(19) United States
(12) Patent Application Publication
(10) Pub. No.: US 2025/0093187 A1
(43) Pub. Date: Mar. 20, 2025

(54) NON-INVASIVE INDIVIDUAL WATER METER AT THE POINT OF USE

(71) Applicant: Daniel Guadagnini, Campinas (BR)

(72) Inventor: Daniel Guadagnini, Campinas (BR)

(21) Appl. No.: 18/623,304

(22) Filed: Apr. 1, 2024

(30) Foreign Application Priority Data
Sep. 14, 2023 (BR) 102023018687

(51) Int. Cl. G01F 1/10; H04W 4/38

(52) U.S. Cl. CPC G01F 1/103; H04W 4/38

(57) ABSTRACT

After reading the consumption, through a turbine flow meter (7), the data is sent by an RF module (9) to the internet (11), which can be via a data concentrator (10) or directly, depending on the RF module technology to a data server (12) where they are stored and made available to the end user via access to a cell phone application (13) or computer software (14).

### INTRODUCTION

This patent application refers to a novel “NON-INVASIVE INDIVIDUAL WATER METER AT THE POINT OF USE”, which replaces the conventional water meter with a compact consumption reading system installed at all water outlets to be monitored, i.e., at consumption points where hydraulic appliances are present, such as showers, faucets, and toilets.

### SCOPE

The invention is applied in the segment of individualized water measurement management equipment in residential and/or commercial/industrial buildings.

### BACKROUND

In Brazil, buildings over 20 years old are not equipped to receive individual water metering systems, as they have multiple water risers, which can amount to more than fifteen water risers in the same consumption unit (apartment). So many risers make it unfeasible to install individual consumption systems, either due to cost or the civil engineering alterations required for the installation of the systems themselves.

Currently, individual water metering is carried out using water meters, hydrometers, at the water inlet of the units to be measured, and each meter is connected to a telemetry system for remote consumption measurement, either wirelessly or wired.

In this context, new technologies capable of enabling remote individualized measurement in buildings with multiple risers in a residential unit are welcome in the segment in question.

### State of the Art

The current state of the art anticipates some patent documents that deal with remote building meters, such as document PI 0005580-8 entitled “FLOW CONTROL AND MEASUREMENT DEVICE FOR WATER SUPPLY HYDRAULIC NETWORKS”—for digital consumption measurement individual in each apartment or unit, consisting of a tube segment, equipped with ends provided with thread and flange for connection to the unit's water inlet pipe, the tube being equipped with a rectangular housing containing the printed circuit board, incorporating a radio frequency transmitter and a flow controller rotor coupled to a microgenerator for the system, with a central reading device, housed in a rectangular box, powered by batteries or external power grid, featuring a display for data measurement, through the insertion of a password.

The aforementioned prior art document, despite enabling remote measurement, does not allow easy installation at the consumption points of residential units in a building with multiple risers. Therefore, civil works must be carried out to connect the tube to the supply piping of these consumption points, which makes installation unfeasible. Another drawback is aesthetics, as the cabinet may not always visually match the environment. Additionally, the need for a micro-generator to power the system increases construction complexity and product cost.

The document PI 0706444-6 A2 titled “WATER METER REMOTE READING DEVICE” refers to a water meter remote reading device, comprising a data acquisition set for consumption data and at least one radio transmitter to transmit the acquired information, at least one radio receiver integrated into the acquisition set to make the said device communicative in both directions to receive information from a central unit, and an antenna for the central unit to emit date and time marking information so that this transmission of information, taken into account by said radio receivers, ensures precise date and time marking of all meter acquisition sets forming the same park. This meter starts measuring the consumed volume at a time determined by a first date and time marking received from the central unit by the receiver and stops at a time determined by a second date and time marking received from the central unit by the receiver, with the volume consumed between the two date and time markings stored in memory and then transmitted to the central unit through the transmitter at a later time.

The aforementioned prior art document deals with data transmission in a central unit determining the reading period for the devices.

### Objectives of the Invention

The objective of the present invention is to propose a non-invasive individual water meter at the point of use, i.e., one that does not require civil works for installation at the water consumption points of residential units in buildings with multiple risers, requiring only a simple hydraulic connection to the faucet, shower, toilet, etc.

The objective of the present invention is to propose a non-invasive individual water meter at the point of use suitable for any type of building, including older ones with multiple hydraulic risers, solving the problem of individualized measurement in a practical and low-cost manner, without the need for civil works.

The objective of the present invention is to propose a non-invasive individual water meter at the point of use with a long-lasting battery, approximately eight years, making the manufactured product less complex and cheaper, as it does not require a micro-generator.

The objective of the present invention is to propose a non-invasive individual water meter at the point of use capable of sending leak and abnormal consumption alerts.

The objective of the present invention is to propose a non-invasive individual water meter at the point of use where data visualization and management can be done via a mobile application.

The objective of the present invention is to propose a non-invasive individual water meter at the point of use with an excellent cost-benefit ratio.

### Summary of the Invention

The “NON-INVASIVE INDIVIDUAL WATER METER AT THE POINT OF USE”-does not require any type of civil works for its installation, since it is installed at every water outlet point of the consuming unit. The equipment is capable of measuring consumption and wirelessly transmitting this data to a server on the internet where it is made available to the user for individual consumption verification.

### FIGURES OF THE INVENTION

Following are the figures to better explain the patent application in an illustrative and non-limiting manner:

FIG. 1 is a perspective view of the non-invasive individual water meter at the point of use;

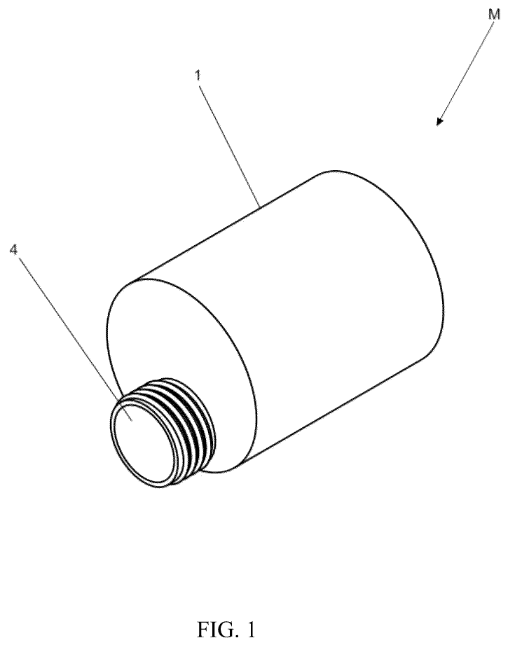

FIG. 2 is an inverted perspective view of the non-invasive individual water meter at the point of use;

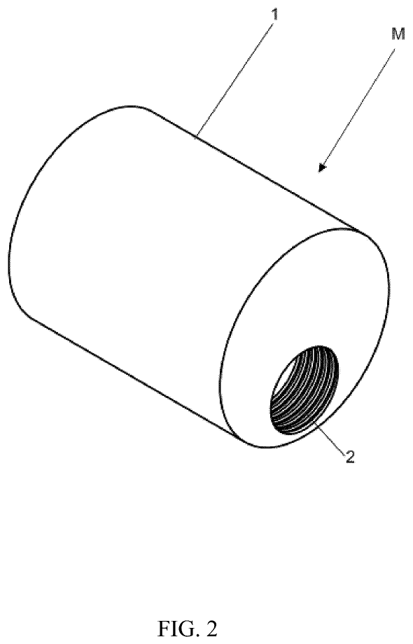

FIG. 3 is schematic view of the non-invasive individual water meter at the point of use;

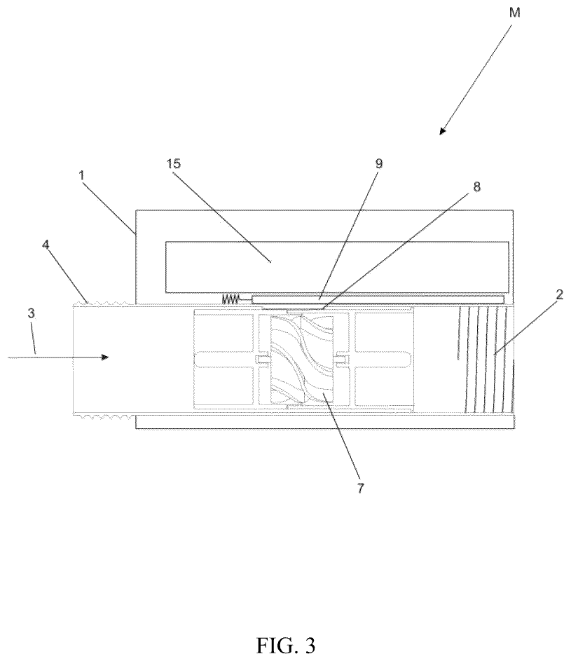

FIG. 4 illustrates the architecture of the non-invasive individual water meter at the point of use;

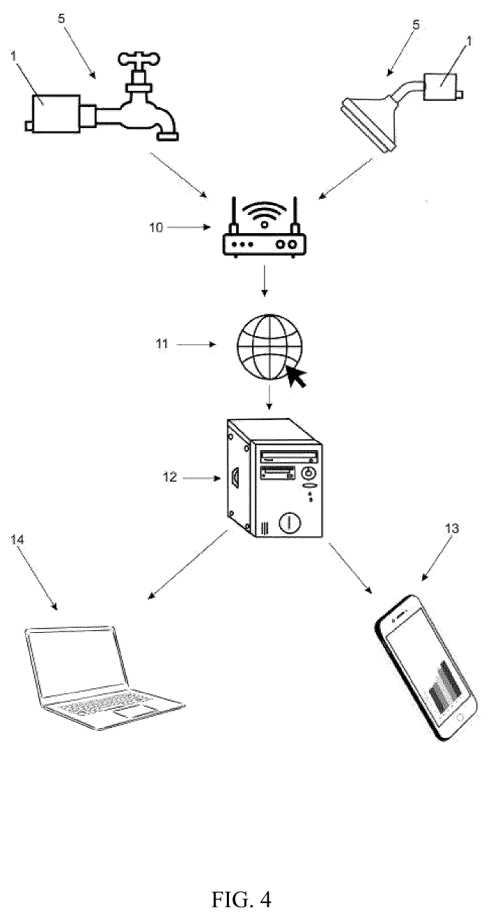

FIG. 5 is a perspective view of the non-invasive individual water meter at the point of use, showing use on a faucet with enlarged detail; and

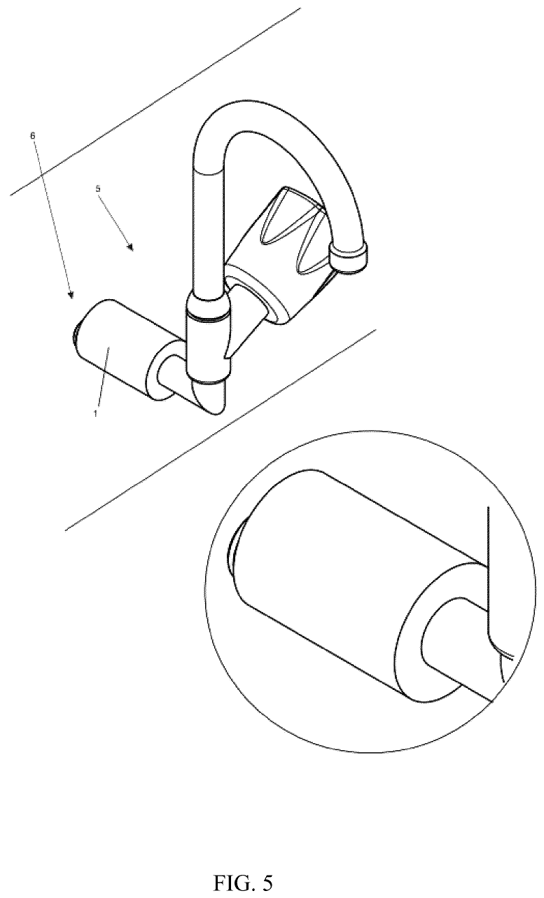

FIG. 6 is a perspective view of the non-invasive individual water meter at the point of use, showing use in a shower.

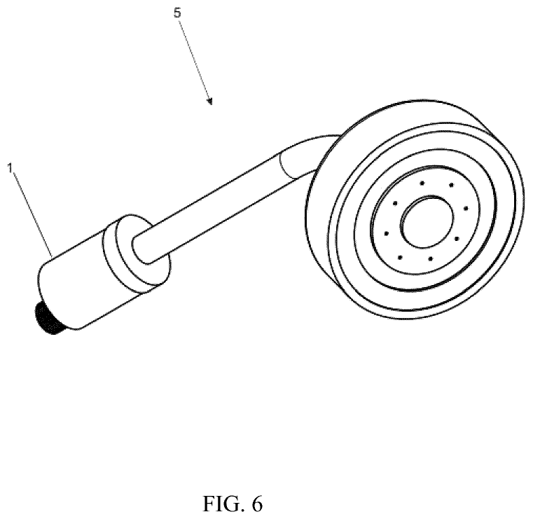

### DETAILED DESCRIPTION OF THE INVENTION

The “NON-INVASIVE INDIVIDUAL WATER METER AT THE POINT OF USE”, object of this invention patent application after reading the consumption, through a flow meter with turbine (7), the data is sent by an RF module (9), to the internet (11), which can be via a data concentrator (10) or directly, depending on the RF module technology to a data server (12) where they are stored and made available to the end user via access to a cell phone application (13) or computer software (14).

The “NON-INVASIVE INDIVIDUAL WATER METER AT THE POINT OF USE”—formed by a tubular body (1) with access (2) for the water flow (3) from a certain pipe of the building and at the distal end a tube (4) of external connection that feeds the point of use (5) of the residential unit, which can be a faucet, a shower, a toilet or similar equipment, thus enabling installation in any building, including those with several pipes, just by making the hydraulic connection between the point of use (5) and the water flow outlet (6), without the need for civil works.

The tubular body (1) of the meter (M) houses a turbine flow meter (7) with magnetic fins that rotates according to the water flow (3), this rotation being captured externally to said tubular body (1) by means of a magnetic sensor (8) type reed switch or Hall effect sensor is read by a microcontroller. The pulses are stored in an internal memory incrementally and transmitted periodically via wireless network by an RF module (9) to a data concentrator (10) the data is sent by an RF module (9), which can be of various types of different modulations, such as LoRa, Sigfox, NB-IoT, LTE-M, cellular network (3G, 4G, 5G), via network to a concentrator (10) for LoRa, Sigfox networks, and this periodically sends the data to the Internet (11), via cellular network or Ethernet. For NB-IoT, LTE-M, and cellular network, there is no need to use the concentrator (10), the data is transmitted directly to the internet (11) to a data server (12) where they are stored and made available to the end user via access to a cell phone application (13) or computer software (14). The system is powered by an internal battery (15) that has a long life, generally greater than 8 years.

1. (canceled)

2. A non-invasive water meter comprising:
a tubular body having an inlet and outlet;
a flow meter having a turbine with magnetic fins rotating with water flow, the rotation of the turbine using a magnetic sensor whose data is read by a microcontroller;
a radio frequency (RF) module;
an internal memory; and
wherein data from the flow meter regarding water flow is incrementally stored in the internal memory and transmitted periodically to a wireless network using the RF module.

3. The water meter of claim 2, where the magnetic sensor is a reed switch.

4. The water meter of claim 2, where the magnetic sensor is a Hall effect sensor.

5. The water meter of claim 2, wherein data is communicated over the internet using at least one of WiFi, a Long Range (LoRa) network or a NarrowBand-Internet of Things (NB-IoT) network.

6. The water meter of claim 2, further comprising a data server for storing data received over a wireless network for use via a cell phone application.

7. A non-invasive water meter comprising:
a tubular body having a water inlet and water outlet;
a flow meter using a turbine having magnetic fins that rotates with water flow, the rotation of the turbine using a Hall effect sensor external to the tubular body whose data is read by a microcontroller;
a radio frequency (RF) module;
an internal memory; and
wherein flow data from the flow meter regarding water flow is incrementally stored in the internal memory and transmitted periodically to a wireless network using the RF module.

8. The water meter of claim 7, wherein the RF module communicates data using at least one of WiFi, a Long Range (LoRa) network or a NarrowBand-Internet of Things (NB-IoT) network.

9. The water meter of claim 7, where a data server receives data from the RF module for use with a cell phone application.

10. The water meter of claim 7, where the data in the internal memory can be viewed using a cell phone application.

11. A water meter for reading flow information through a pipe comprising:
a tubular body having a water inlet and water outlet;
a flow meter using an internal turbine that uses magnetic fins that rotating with water flow, the rotation of the turbine using a Hall effect sensor external to the tubular body whose data is read by a microcontroller;
a radio frequency (RF) module;
an internal memory; and
wherein water flow data from the flow meter is incrementally stored in the internal memory and transmitted periodically to a data server which stores flow that can be viewed using an application on a mobile device.

12. The water meter of claim 11, wherein the RF module communicates data using at least one of WiFi, a Long Range (LoRa) network or a NarrowBand-Internet of Things (NB-IoT) network.
